(19) United States
(12) Patent Application Publication
(10) Pub. No.: US 2024/0169272 A1
(43) Pub. Date: May 23, 2024

(54) Machine Learning Model for Detecting Out-Of-Distribution Inputs

(71) Applicant: Google LLC, Mountain View, CA (US)

(72) Inventors: Patricia MacWilliams, London (GB); Abhijit Guha Roy, London (GB); Jim Winkens, New York, NY (US); Alan Karthikesalingam, London (GB); Jie Ren, San Jose, CA (US); Balaji Lakshminarayanan, Sunnyvale, CA (US)

(21) Appl. No.: 18/551,847

(22) PCT Filed: Feb. 7, 2022
(86) PCT No.: PCT/US2022/070552

§ 371 Date: Sep. 21, 2023

Related U.S. Application Data
(60) Provisional application No. 63/168,737, filed on Mar. 31, 2021.

(51) Int. Cl. G06N 20/00

(52) U.S. Cl. CPC G06N 20/00

(57) ABSTRACT

A method includes determining, by a machine learning model and based on input data, a feature map that represents learned features present in the input data. The method also includes, for each respective inlier class of a plurality of inlier classes, determining, by the machine learning model and based on the feature map, a corresponding inlier score indicative of a probability that the input data belongs to the respective inlier class. The method additionally includes, for each respective outlier class of a plurality of outlier classes, determining, by the machine learning model and based on the feature map, a corresponding outlier score indicative of a probability that the input data belongs to the respective outlier class. The method further includes determining, based on the inlier scores and the outlier scores, whether the input data corresponds to the plurality of inlier classes or to the plurality of outlier classes.

### CROSS-REFERENCE TO RELATED APPLICATIONS

This application claims priority to U.S. provisional patent application No. 63/168,737, filed on Mar. 31, 2021, which is hereby incorporated by reference as if fully set forth in this description.

### BACKGROUND

Machine learning models may be used to process various types of data, including images, audio, time series, text, and/or point clouds, among other possibilities. Improvements in the machine learning models allow the models to carry out the processing of data faster, generate more accurate results, and/or utilize fewer computing resources during processing of the data. Machine learning models may be used for various applications and/or in various contexts, such autonomous device control, medicine, and/or text/speech translation, among others. Accordingly, improvements in the machine learning models may also provide commensurate improvements in these various applications and/or contexts.

### SUMMARY

A machine learning model may be configured to determine whether it has been adequately trained to generate an output resulting from processing of input data by the machine learning model. The machine learning model may be a classifier configured to classify the input data among a plurality of classes. Specifically, the machine learning model may be configured to generate, based on the input data and for each respective class of the plurality of classes, a corresponding class score. The plurality of classes may include a plurality of inlier classes and a plurality of outlier classes. The machine learning model may have been adequately trained to classify input data among the inlier classes, but not among the outlier classes. When a sum of the respective scores of the inlier classes exceeds a sum of the respective scores of the outlier classes, the machine learning model may be configured to determine that it is qualified to generate a classification and may classify the input data into one of the inlier classes. Otherwise, the machine learning model may, for example, abstain from classifying the input data into one of the outlier classes.

In a first example embodiment, a method may include obtaining input data. The method may also include determining, by a machine learning model and based on the input data, a feature map that represents learned features present in the input data. The method may additionally include, for each respective inlier class of a plurality of inlier classes, determining, by the machine learning model and based on the feature map, a corresponding inlier score indicative of a probability that the input data belongs to the respective inlier class. The machine learning model may have been trained using at least a threshold number of training samples for each respective inlier class. The method may further include, for each respective outlier class of a plurality of outlier classes, determining, by the machine learning model and based on the feature map, a corresponding outlier score indicative of a probability that the input data belongs to the respective outlier class. The machine learning model may have been trained using fewer than the threshold number of training samples for each respective outlier class. The method may yet further include determining, based on (i) the corresponding inlier score for each respective inlier class and (ii) the corresponding outlier score for each respective outlier class, whether the input data corresponds to the plurality of inlier classes or to the plurality of outlier classes.

In a second example embodiment, a system may include a processor and a non-transitory computer-readable medium having stored thereon instructions that, when executed by the processor, cause the processor to perform operations. The operations may include obtaining input data. The operations may also include determining, by a machine learning model and based on the input data, a feature map that represents learned features present in the input data. The operations may additionally include, for each respective inlier class of a plurality of inlier classes, determining, by the machine learning model and based on the feature map, a corresponding inlier score indicative of a probability that the input data belongs to the respective inlier class. The machine learning model may have been trained using at least a threshold number of training samples for each respective inlier class. The operations may further include, for each respective outlier class of a plurality of outlier classes, determining, by the machine learning model and based on the feature map, a corresponding outlier score indicative of a probability that the input data belongs to the respective outlier class. The machine learning model may have been trained using fewer than the threshold number of training samples for each respective outlier class. The operations may yet further include determining, based on (i) the corresponding inlier score for each respective inlier class and (ii) the corresponding outlier score for each respective outlier class, whether the input data corresponds to the plurality of inlier classes or to the plurality of outlier classes.

In a third example embodiment, a non-transitory computer-readable medium may have stored thereon instructions that, when executed by a computing device, cause the computing device to perform operations. The operations may include obtaining input data. The operations may also include determining, by a machine learning model and based on the input data, a feature map that represents learned features present in the input data. The operations may additionally include, for each respective inlier class of a plurality of inlier classes, determining, by the machine learning model and based on the feature map, a corresponding inlier score indicative of a probability that the input data belongs to the respective inlier class. The machine learning model may have been trained using at least a threshold number of training samples for each respective inlier class. The operations may further include, for each respective outlier class of a plurality of outlier classes, determining, by the machine learning model and based on the feature map, a corresponding outlier score indicative of a probability that the input data belongs to the respective outlier class. The machine learning model may have been trained using fewer than the threshold number of training samples for each respective outlier class. The operations may yet further include determining, based on (i) the corresponding inlier score for each respective inlier class and (ii) the corresponding outlier score for each respective outlier class, whether the input data corresponds to the plurality of inlier classes or to the plurality of outlier classes.

In a fourth example embodiment, a system may include means for obtaining input data. The system may also include means for determining, by a machine learning model and based on the input data, a feature map that represents learned features present in the input data. The system may additionally include means for determining, for each respective inlier class of a plurality of inlier classes, by the machine learning model, and based on the feature map, a corresponding inlier score indicative of a probability that the input data belongs to the respective inlier class. The machine learning model may have been trained using at least a threshold number of training samples for each respective inlier class. The system may further include means for determining, for each respective outlier class of a plurality of outlier classes, by the machine learning model, and based on the feature map, a corresponding outlier score indicative of a probability that the input data belongs to the respective outlier class. The machine learning model may have been trained using fewer than the threshold number of training samples for each respective outlier class. The system may yet further include means for determining, based on (i) the corresponding inlier score for each respective inlier class and (ii) the corresponding outlier score for each respective outlier class, whether the input data corresponds to the plurality of inlier classes or to the plurality of outlier classes.

In a fifth example embodiment, a method may include obtaining training input data associated with a ground-truth class, and determining, by a machine learning model and based on the training input data, a training feature map that represents learned features present in the training input data. The method may also include, for each respective inlier class of a plurality of inlier classes, determining, by the machine learning model and based on the training feature map, a corresponding inlier training score indicative of a probability that the training input data belongs to the respective inlier class. The method may additionally include, for each respective outlier class of a plurality of outlier classes, determining, by the machine learning model and based on the training feature map, a corresponding outlier training score indicative of a probability that the training input data belongs to the respective outlier class. The method may yet additionally include determining a fine-grained loss value based on a training score of the ground-truth class, where the training score is the corresponding inlier training score for an inlier class corresponding to the ground-truth class or the corresponding outlier training score for an outlier class corresponding to the ground-truth class. The method may further include determining a coarse-grained loss value based on (i) a first training sum of the corresponding inlier training score for each respective inlier class when the ground-truth class is an inlier or (ii) a second training sum of the corresponding outlier training score for each respective outlier class when the ground-truth class is an outlier. The method may yet further include adjusting one or more parameters of the machine learning model based on the fine-grained loss value and the coarse-grained loss value.

In a sixth example embodiment, a system may include a processor and a non-transitory computer-readable medium having stored thereon instructions that, when executed by the processor, cause the processor to perform operations. The operations may include obtaining training input data associated with a ground-truth class, and determining, by a machine learning model and based on the training input data, a training feature map that represents learned features present in the training input data. The operations may also include, for each respective inlier class of a plurality of inlier classes, determining, by the machine learning model and based on the training feature map, a corresponding inlier training score indicative of a probability that the training input data belongs to the respective inlier class. The operations may additionally include, for each respective outlier class of a plurality of outlier classes, determining, by the machine learning model and based on the training feature map, a corresponding outlier training score indicative of a probability that the training input data belongs to the respective outlier class. The operations may yet additionally include determining a fine-grained loss value based on a training score of the ground-truth class, where the training score is the corresponding inlier training score for an inlier class corresponding to the ground-truth class or the corresponding outlier training score for an outlier class corresponding to the ground-truth class. The operations may further include determining a coarse-grained loss value based on (i) a first training sum of the corresponding inlier training score for each respective inlier class when the ground-truth class is an inlier or (ii) a second training sum of the corresponding outlier training score for each respective outlier class when the ground-truth class is an outlier. The operations may yet further include adjusting one or more parameters of the machine learning model based on the fine-grained loss value and the coarse-grained loss value.

In a seventh example embodiment, a non-transitory computer-readable medium may have stored thereon instructions that, when executed by a computing device, cause the computing device to perform operations. The operations may include obtaining training input data associated with a ground-truth class, and determining, by a machine learning model and based on the training input data, a training feature map that represents learned features present in the training input data. The operations may also include, for each respective inlier class of a plurality of inlier classes, determining, by the machine learning model and based on the training feature map, a corresponding inlier training score indicative of a probability that the training input data belongs to the respective inlier class. The operations may additionally include, for each respective outlier class of a plurality of outlier classes, determining, by the machine learning model and based on the training feature map, a corresponding outlier training score indicative of a probability that the training input data belongs to the respective outlier class. The operations may yet additionally include determining a fine-grained loss value based on a training score of the ground-truth class, where the training score is the corresponding inlier training score for an inlier class corresponding to the ground-truth class or the corresponding outlier training score for an outlier class corresponding to the ground-truth class. The operations may further include determining a coarse-grained loss value based on (i) a first training sum of the corresponding inlier training score for each respective inlier class when the ground-truth class is an inlier or (ii) a second training sum of the corresponding outlier training score for each respective outlier class when the ground-truth class is an outlier. The operations may yet further include adjusting one or more parameters of the machine learning model based on the fine-grained loss value and the coarse-grained loss value.

In an eighth example embodiment, a system may include means for obtaining training input data associated with a ground-truth class, and means for determining, by a machine learning model and based on the training input data, a training feature map that represents learned features present in the training input data. The system may also include means for determining, for each respective inlier class of a plurality of inlier classes, by the machine learning model, and based on the training feature map, a corresponding inlier training score indicative of a probability that the training input data belongs to the respective inlier class. The system may additionally include means for determining, for each respective outlier class of a plurality of outlier classes, by the machine learning model, and based on the training feature map, a corresponding outlier training score indicative of a probability that the training input data belongs to the respective outlier class. The system may yet additionally include means for determining a fine-grained loss value based on a training score of the ground-truth class, where the training score is the corresponding inlier training score for an inlier class corresponding to the ground-truth class or the corresponding outlier training score for an outlier class corresponding to the ground-truth class. The system may further include means for determining a coarse-grained loss value based on (i) a first training sum of the corresponding inlier training score for each respective inlier class when the ground-truth class is an inlier or (ii) a second training sum of the corresponding outlier training score for each respective outlier class when the ground-truth class is an outlier. The system may yet further include means for adjusting one or more parameters of the machine learning model based on the fine-grained loss value and the coarse-grained loss value.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a computing system, in accordance with examples described herein.

FIG. 2 illustrates a long tail distribution, in accordance with examples described herein.

FIG. 3 illustrates a machine learning model, in accordance with examples described herein.

FIG. 4 illustrates aspects of training of the machine learning model of FIG. 3, in accordance with examples described herein.

FIG. 5 illustrates a partition of a training data set, in accordance with examples described herein.

FIGS. 6A, 6B, 6C, and 6D illustrate performance metrics of variants of the machine learning model of FIG. 3, in accordance with examples described herein.

FIG. 7 illustrates a flow chart, in accordance with examples described herein.

FIG. 8 illustrates a flow chart, in accordance with examples described herein.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example,” “exemplary,” and/or “illustrative” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order. Unless otherwise noted, figures are not drawn to scale.

### I. Overview

Some machine learning models (e.g., neural networks) may be trained to perform one or more desired operations using training data. For example, a machine learning model may be trained to classify input data among a plurality of classes (e.g., groupings or categories). In order to achieve at least a threshold performance metric at inference time, the machine learning model may be trained using at least a threshold number of different examples associated with each class of the plurality of classes. The threshold number of different examples may expose the machine learning model to sufficient inter-class and intra-class variations and/or commonalities, thus allowing the machine learning model to distinguish even among classes that may have very similar characteristics.

In some cases, the available training data might not be completely representative of a full scope of the input data that could potentially be encountered at inference time. For example, when the machine learning model is a classifier, it may be difficult, impractical, and/or infeasible to collect sufficient training data for each potential class that could be encountered at inference time. Accordingly, some classes may be represented within the training data set using fewer than the threshold number of samples, while other classes might not be represented in the training data set at all. Classes for which the training data includes at least the threshold number of training samples may be referred to herein as inliers and/or inlier classes. Classes for which the training data includes fewer than the threshold number of training samples may be referred to herein as outliers and/or outlier classes.

In some cases, input data belonging to a particular outlier class may be misclassified due to the machine learning model not having been trained with a sufficient number of training samples for the particular outlier class. Further, the machine learning model and/or its user might not be aware that the machine learning model is not qualified, trusted, and/or approved to be used with input data belonging to the particular outlier class. Such misclassification may be likely when, for example, the particular outlier class is similar to (e.g., shares characteristics with) an inlier class. Accordingly, reliance on the output of the machine learning model in such cases may be undesirable. For example, when the machine learning model is used to assist with a medical diagnosis, misclassification may lead to a misdiagnosis of a medical condition represented by the input data. Repeated misclassifications may lead to a decrease in clinicians' and/or patients' trust in outputs of the machine learning model.

Accordingly, provided herein are machine learning model architectures and training processes configured to reduce and/or eliminate the frequency of misclassification of samples associated with an outlier class. Specifically, based on the number of training samples available for each respective class of a plurality of classes in a training data set, the plurality of classes may be partitioned into outlier classes and inlier classes. The machine learning model may be trained to generate, based on input data, a corresponding score for each respective class of the plurality of classes. Additionally, the machine learning model may be configured to determine an inlier (first) sum of corresponding scores of the inlier classes, and an outlier (second) sum of corresponding scores of the outlier classes.

Based on the relative values of the inlier sum and the outlier sum, the machine learning model may be configured to determine whether the input data is an inlier for which the machine learning model is qualified to generate a classification, or an outlier for which the machine learning model is not qualified to generate a classification. For example, the input data may be considered an inlier (i.e., corresponding to the inlier classes) when the inlier sum exceeds the outlier sum (e.g., by at least a threshold), and the input data may be considered an outlier (i.e., corresponding to the outlier classes) when the inlier sum does not exceed the outlier sum (e.g., by at least the threshold).

In addition to generating this coarse-grained (i.e., inlier vs outlier) classification, the machine learning model may also be configured to, when the input data is determined to be an inlier, assign a specific inlier class to the input data, since the machine learning model is qualified to do so for inliers. On the other hand, when the input data is determined to be an outlier, the machine learning model may be configured to abstain from generating a fine-grained classification for the input data, since the machine learning model is not qualified to do so for outliers.

The machine learning model may be trained to perform this hierarchical, two-level classification using a coarse-grained loss function and a fine-grained loss function. The coarse-grained loss function may be used to evaluate an extent to which the machine learning model correctly performs the coarse-grained classification of a training sample as either an inlier or an outlier, and may be independent of the fine-grained selection of a particular class for the training sample. The fine-grained loss function may be used to evaluate an extent to which the machine learning model correctly performs the fine-grained selection of a particular class for the training sample, and may be independent of the coarse-grained classification of the training sample as either an inlier or an outlier. An overall loss function may be based on a weighted sum of the fine-grained loss function and the coarse-grained loss function, thus improving and/or optimizing the machine learning model's ability to perform both levels of classification.

The resulting machine learning model may be configured to operate on previously-unseen input data corresponding to classes that were represented during training, as well as previously-unseen input data corresponding to classes that were not represented during training. Specifically, the machine learning model may be trained to preferentially “distribute” the scoring of a previously-unseen outlier input data among the plurality of outlier classes (rather than inlier classes) that were represented during training to thereby indicate that the previously-unseen outlier input data is an outlier. Indicating whether an input is an outlier or an inlier may allow the machine learning model to more clearly communicate the confidence in its predictions to down-stream systems and/or users, thus improving performance and/or trustworthiness of the machine learning model.

### II. Example System

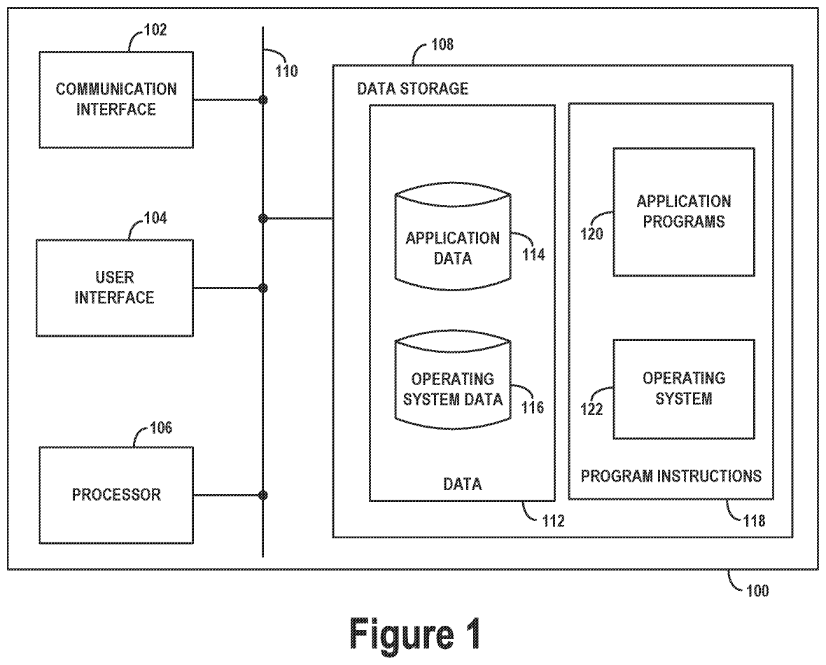

FIG. 1 is a simplified block diagram showing some of the components of an example computing system 100. By way of example and without limitation, computing system 100 may be a cellular mobile telephone (e.g., a smartphone), a computer (such as a desktop, server, notebook, tablet, or handheld computer), a home automation component, a digital video recorder (DVR), a digital television, a remote control, a wearable computing device, a gaming console, a robotic device, a vehicle, or some other type of device.

As shown in FIG. 1, computing system 100 may include communication interface 102, user interface 104, processor 106, and data storage 108, all of which may be communicatively linked together by a system bus, network, or other connection mechanism 110. In some implementations, computing system 100 may be equipped with at least some data (e.g., image, audio, point cloud, etc.) capture and/or processing capabilities. Computing system 100 may represent a physical data processing system, a particular physical hardware platform on which a data capture and/or processing application operates in software, or other combinations of hardware and software that are configured to carry out data capture and/or processing functions.

Communication interface 102 may allow computing system 100 to communicate, using analog or digital modulation, with other devices, access networks, and/or transport networks. Thus, communication interface 102 may facilitate circuit-switched and/or packet-switched communication, such as plain old telephone service (POTS) communication and/or Internet protocol (IP) or other packetized communication. For instance, communication interface 102 may include a chipset and antenna arranged for wireless communication with a radio access network or an access point. Also, communication interface 102 may take the form of or include a wireline interface, such as an Ethernet, Universal Serial Bus (USB), or High-Definition Multimedia Interface (HDMI) port. Communication interface 102 may also take the form of or include a wireless interface, such as a Wi-Fi, BLUETOOTH®, global positioning system (GPS), or wide-area wireless interface (e.g., WiMAX or 3GPP Long-Term Evolution (LTE)). However, other forms of physical layer interfaces and other types of standard or proprietary communication protocols may be used over communication interface 102. Furthermore, communication interface 102 may comprise multiple physical communication interfaces (e.g., a Wi-Fi interface, a BLUETOOTH® interface, and a wide-area wireless interface).

User interface 104 may function to allow computing system 100 to interact with a human or non-human user, such as to receive input from a user and to provide output to the user. Thus, user interface 104 may include input components such as a keypad, keyboard, touch-sensitive panel, computer mouse, trackball, joystick, microphone, and so on. User interface 104 may also include one or more output components such as a display screen which, for example, may be combined with a touch-sensitive panel. The display screen may be based on CRT, LCD, and/or LED technologies, or other technologies now known or later developed. User interface 104 may also be configured to generate audible output(s), via a speaker, speaker jack, audio output port, audio output device, earphones, and/or other similar devices. User interface 104 may also be configured to receive and/or capture audible utterance(s), noise(s), and/or signal(s) by way of a microphone and/or other similar devices.

In some examples, user interface 104 may include a display that serves as a view finder for still camera and/or video camera functions supported by computing system 100. Additionally, user interface 104 may include one or more buttons, switches, knobs, and/or dials that facilitate the configuration and focusing of a camera function and the capturing of images. It may be possible that some or all of these buttons, switches, knobs, and/or dials are implemented by way of a touch-sensitive panel.

Processor 106 may comprise one or more general purpose processors—e.g., microprocessors—and/or one or more special purpose processors—e.g., digital signal processors (DSPs), graphics processing units (GPUS), floating point units (FPUs), network processors, or application-specific integrated circuits (ASICs). Data storage 108 may include one or more volatile and/or non-volatile storage components, such as magnetic, optical, flash, or organic storage, and may be integrated in whole or in part with processor 106. Data storage 108 may include removable and/or non-removable components.

Processor 106 may be capable of executing program instructions 118 (e.g., compiled or non-compiled program logic and/or machine code) stored in data storage 108 to carry out the various functions described herein. Therefore, data storage 108 may include a non-transitory computer-readable medium, having stored thereon program instructions that, upon execution by computing system 100, cause computing system 100 to carry out any of the methods, processes, or operations disclosed in this specification and/or the accompanying drawings. The execution of program instructions 118 by processor 106 may result in processor 106 using data 112.

By way of example, program instructions 118 may include an operating system 122 (e.g., an operating system kernel, device driver(s), and/or other modules) and one or more application programs 120 (e.g., camera functions, address book, email, web browsing, social networking, audio-to-text functions, text translation functions, and/or gaming applications) installed on computing system 100. Similarly, data 112 may include operating system data 116 and application data 114. Operating system data 116 may be accessible primarily to operating system 122, and application data 114 may be accessible primarily to one or more of application programs 120. Application data 114 may be arranged in a file system that is visible to or hidden from a user of computing system 100.

Application programs 120 may communicate with operating system 122 through one or more application programming interfaces (APIs). These APIs may facilitate, for instance, application programs 120 reading and/or writing application data 114, transmitting or receiving information via communication interface 102, receiving and/or displaying information on user interface 104, and so on.

In some cases, application programs 120 may be referred to as “apps” for short. Additionally, application programs 120 may be downloadable to computing system 100 through one or more online application stores or application markets. However, application programs can also be installed on computing system 100 in other ways, such as via a web browser or through a physical interface (e.g., a USB port) on computing system 100.

In some implementations, computing system 100 may also include camera components, such as an aperture, shutter, recording surface (e.g., photographic film and/or an image sensor), lens, shutter button, infrared projectors, and/or visible-light projectors. The camera components may include components configured for capturing of images in the visible-light spectrum (e.g., electromagnetic radiation having a wavelength of 380-700 nanometers), and/or components configured for capturing of images in the infrared light spectrum (e.g., electromagnetic radiation having a wavelength of 701 nanometers-1 millimeter), among other possibilities. The camera components may be controlled at least in part by software executed by processor 106.

### III. Example Long Tail Distribution

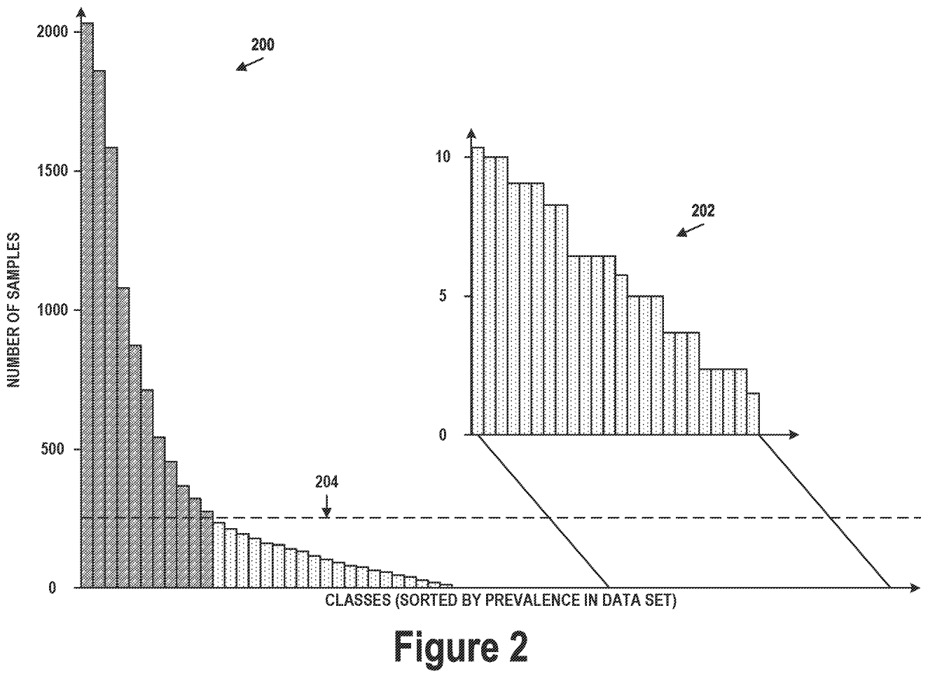

FIG. 2 illustrates an example of a long tail (or long-tailed) distribution of training data for a machine learning model. Specifically, FIG. 2 includes graph 200 that shows, on a vertical axis thereof, a number of samples associated with each of a plurality of different and/or disjoint classes represented by a training data set. A horizontal axis of graph 200 shows the plurality of classes sorted according to a prevalence of corresponding samples in the training data set. Graph 202 shows an enlarged version of a rightmost portion of graph 200. A most prevalent class shown in graph 200 is associated with over two thousand samples, while a least prevalent class shown in graph 202 is associated with as little as one sample, with other classes being associated with a number of samples between (i) two thousand and (ii) one. A sample may alternatively be referred to herein as a case and/or instance, and may be associated with and/or defined by one or more subsamples.

In some implementations, each respective class of the plurality of classes shown in graph 200 may represent a particular type and/or variant of a medical condition, while the number of samples of the respective class may represent a number of examples in the data set of (e.g., number of patients with) the respective type and/or variant of the medical condition. For example, each respective class of the plurality of classes may represent a particular dermatological condition (e.g., eczema, lupus, melasma, etc.), while the number of samples of the respective class may represent a number of patients in the data set with the respective dermatological condition. Each patient's respective dermatological condition may be represented by, for example, one or more images of the patient's skin region(s). In other examples, the plurality of classes may correspond to various other medical conditions that may be represented by and/or diagnosed based on, for example, chest X-rays, brain computed tomography (CT) scans, fundus images, and/or other types of representations of various anatomical parts.

Line 204 represents a threshold number of samples that partitions (i.e., divides) the classes in the data set into inlier classes (alternatively referred to as inliers and/or in-distribution classes) and outlier classes (alternatively referred to as outliers and/or out-of-distribution classes). Inlier classes are shown in graph 200 using a relatively darker shading, while outlier classes are shown using a relatively lighter shading. Specifically, the threshold number of samples may indicate a minimum number of training samples that, when used to train a machine learning model, allow the machine learning model to generate classifications (or other types of output) with at least a threshold accuracy and/or other threshold performance metric. The threshold number of samples may be determined empirically and/or computationally, and may vary among different applications/use-cases, different machine learning model architectures, and/or other factors.

The data set shown in graph 200 may be expressed as D={(x₁, y₁), . . . , (x_{M}, y_{M})}, where xᵢ for i=1, . . . , M indicates input data that represents the ith sample, yᵢ indicates the ground-truth classification of the ith sample, and yᵢ∈Y. The set of classes Y present in D is made up of the inlier classes Y_{IN} and the outlier classes Y_{OUT}. Thus, Y=Y_{IN}∪Y_{OUT}, with Y_{IN}={y: N_{MIN}≤Σ_{(x′, y′)∈D} 1 (y′=y)} and Y_{OUT}={y: N_{MIN}>Σ_{(x′, y′)∈D} 1(y′=y)}, where N_{MIN} represents the threshold number of samples corresponding to line 204, and 1(y′=y) is equal to 1 when input data x′ associated with ground-truth classification y′ belongs to the class y (i.e., when the statement within the parentheses is true) and 0 otherwise.

When a previously-unseen sample is provided as input to the machine learning model trained using the data set shown in graph 200, a corresponding output of the machine learning model may be more accurate when the previously-unseen sample actually belongs to an inlier class than when the previously-unseen sample actually belongs to an outlier class. Specifically, the machine learning model may be qualified, trusted, and/or approved to generate classifications of previously-unseen samples that are inliers, but might not be qualified, trusted, and/or approved to generate classifications of previously-unseen samples that are outliers. Thus, when a previously-unseen sample is actually an outlier, it may be desirable for the machine learning model to indicate that the classification generated by the machine learning model is uncertain, indicate that the machine learning model is not qualified, trusted, and/or approved to make the classification, indicate that the previously-unseen sample is an outlier, and/or abstain from generating a classification.

### IV. Example Model for Detecting Inliers and/or Outliers

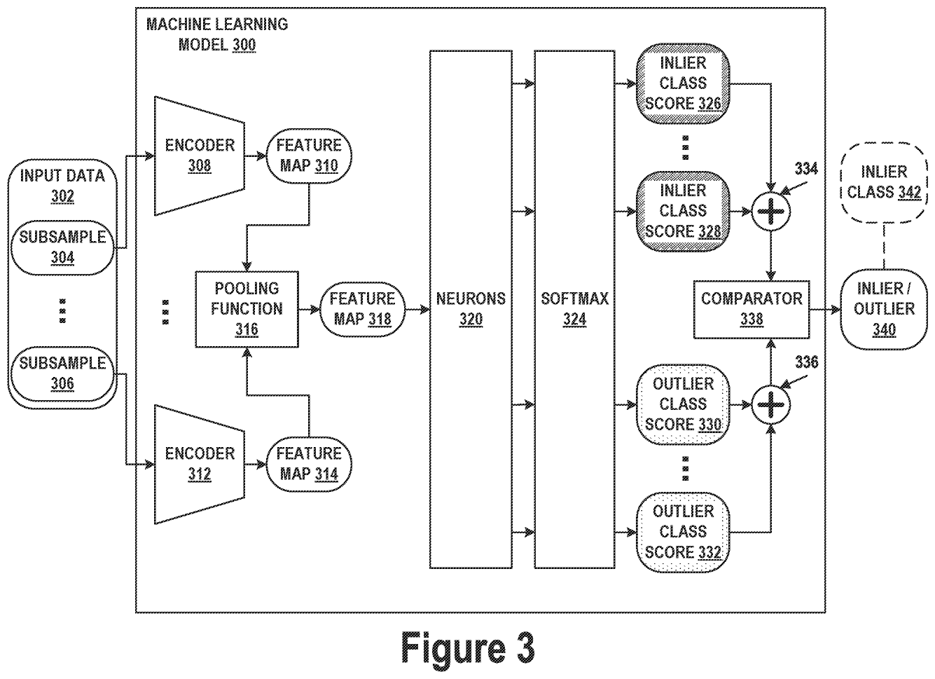

FIG. 3 illustrates aspects of an example machine learning model that is configured to determine whether a previously-unseen sample actually belongs to an inlier class or to an outlier class. Specifically, FIG. 3 illustrates machine learning model 300, which may be configured to, based on input data 302, generate inlier/outlier classification 340 and, in some cases, determine inlier class 342. Machine learning model 300 may include encoder 308 through encoder 312 (i.e., encoders 308-312), pooling function 316, neurons 320, softmax function 324, adder 334, adder 336, and comparator 338.

Input data 302 may represent a previously-unseen sample (i.e., a sample that machine learning model 300 has not been trained on) to be classified by machine learning model 300. Input data 302 may be associated with a corresponding class, which may be referred to as the actual class and/or a ground-truth class of input data 302, although this corresponding class might not be represented as part of input data 302. Input data 302 may include one or more subsamples. In FIG. 3, input data 302 is shown as including subsample 304 through subsample 306 (i.e., subsamples 304-306). Each of subsamples 304-306 may provide a different representation of a single case and/or instance represented by input data 302. Subsamples 304-306 may thus provide representational diversity which may facilitate the classification of input data 302. The number of subsamples 304-306 may vary, for example, from one to six subsamples.

When machine learning model 300 is configured to classify dermatological conditions based on image data, for example, subsamples 304-306 may each represent a corresponding image of one or more skin regions of a particular patient with a skin condition. The images represented by subsamples 304-306 may be captured from different perspectives, at different distances, under different lighting conditions, and/or at different times, among other possible variations, but may nevertheless represent one skin condition of one particular patient. Input data 302 may thus represent a sample corresponding to the skin condition of the particular patient. The variation among the images represented by subsamples 304-306 may facilitate classification of the skin condition because some of the images might represent aspects of the skin condition that might not be apparent from other images, and vice versa.

Although image data representing medical conditions is discussed herein as an example of input data 302, input data 302 may additionally or alternatively represent other types of data. For example, input data 302 may represent audio data, waveform data, point cloud data, and/or text data, among other possibilities. The image data represented by input data may include grayscale image data, red-green-blue (RGB) image data, and/or depth image data (e.g., stereoscoping image data), among other possibilities. Additionally, input data 302 may represent phenomena other than medical conditions, such as, for example, operating environments of autonomous vehicles and/or robotic devices, textual data generated and/or stored by a computing system, and/or spoken words, among other possibilities. Thus, machine learning model 300 may be used in a variety of contexts that may involve the processing of outlier data for which machine learning model 300 might not have been trained with a sufficient number of training samples.

Further, although aspects of machine learning model 300 are discussed in connection with graph 200, which shows a long tail distribution, the techniques discussed herein are also applicable to data sets having other types of distributions, such as the Gaussian distribution, the log-normal distribution, and/or the Poisson distribution, among other possibilities. Thus, the techniques discussed herein may be used when the number of outlier classes exceeds, is equal to, and/or is lower than the number of inlier classes. The benefits of the techniques discussed herein may increase as the number of outlier classes represented in the training data set increases and/or the number of potential outlier classes, some of which might not have been represented in the training data, increases.

Each of encoders 308-312 may be configured to generate a feature map (e.g., vector, matrix, or tensor) that represents learned features that are present in a corresponding subsample of input data 302. Specifically, encoder 308 may be configured to generate feature map 310 based on subsample 304, and encoder 312 may be configured to generate feature map 314 based on subsample 306, with other encoders operating on other corresponding subsamples. In some implementations, encoders 308-312 may share the same parameters, and may thus each be configured to detect the same learned features, albeit in different subsamples. Each of encoders 308-312 may represent one or more machine learning model structures and/or components, the identity and/or arrangement of which may depend on the type of input data 302 being processed. For example, in the case of image data, each of encoders 308-312 may represent one or more residual neural networks (ResNet), such as ResNet-101, which includes one hundred and one layers.

Pooling function 316 may be configured to generate feature map 318 based on feature maps 310-314. Specifically, pooling function 316 may be configured to execute instance level pooling that generates a common feature map for all subsamples 304-306 of input data 302. Pooling function 316 may thus allow the feature maps of a variable number of subsamples 304-306 to be reduced to a common representation. Pooling function 316 may represent, for example, a max pooling function, an average pooling function, a softmax-based pooling function, and/or an attention-based pooling function, among other possibilities. For example, when each of feature maps 310-314 is represented as a W×H×D tensor, pooling function 316 may be configured to combine a plurality of such W×H×D tensors, each representing learned features of a corresponding subsample of subsamples 304-306, into a single W×H×D tensor that represents learned features of input data 302 as a whole.

Neurons 320 may include a plurality of neurons configured to process feature map 318 prior to application of softmax function 324. Each respective neuron of neurons 320 may be connected to at least a subset of feature map 318. For example, when feature map 318 is a W×H×D tensor, each respective neuron of at least one layer formed by neurons 320 may be connected to each of the W×H×D map elements of the tensor, and this layer may thus be considered to be fully-connected. Each respective neuron may be associated with a plurality of weights and/or bias values (modifiable during training), with each weight of the plurality of weights and/or bias value of the plurality of bias values corresponding to a particular connection with feature map 318 and/or other neurons. Neurons 320 may be configured to generate, as output, a vector that includes a plurality of values (e.g., 512) that are representative of feature map 318, and thus also of input data 302.

In some implementations, encoders 308-312 may be pre-trained (e.g., using a first non-task-specific data set), and the parameters thereof might not be adjusted during training of other components of machine learning model 300 (e.g., using a second task-specific data set). Instead, the weights and biases of neurons 320 and/or softmax 324 may be adjusted during training to allow machine learning model 300 to perform classification based on feature map 318. By pre-training encoders 308-312, feature map 318 may include learned features that are represented as part of the pre-training data and that may be present in input data 302, but that might not be represented as part of the training data due to the training data being more narrowly tailored to the task for which machine learning model 300 is being trained.

Softmax function 324 may be configured to generate each of inlier class scores 326 through 328 (i.e., inlier class scores 326-328) and outlier class scores 330 through 332 (i.e., outlier class scores 330-332) based on an output of neurons 320) (i.e., the vector generated by neurons 320). Inlier class scores 326-328 and outlier class scores 330-332 may be collectively referred to as class scores 326-332. Softmax function 324 may include a number of output neurons equal to a number of class scores 326-332 and the normalized exponential function as the activation function of these neurons.

Class scores 326-332 may be expressed as p(c|x)=exp(w_{c}^{T}f(x)+b_{c})/(Σ_{c′∈Y} exp(w_{c′}^{T}f(x)+b_{c′})), where c represents a particular class of the plurality of classes Y among which machine learning model 300 is configured to classify input data, Y is equal to a union of inlier classes Y_{IN} and outlier classes Y_{OUT}, w_{c} represents a matrix of weights associated with an output neuron of the particular class c, b_{c} represents a bias value associated with the output neuron of the particular class c, f(x) represents an output of neurons 320, x represents input data 302, and p(c|x) represents a score of the particular class given input data x.

Each respective class score of class scores 326-332 may be associated with a corresponding class that was represented by one or more samples during training of machine learning model 300. Specifically, inlier class scores 326-328 may correspond to inlier classes for which at least the threshold number of training samples was used to train machine learning model 300, and outlier class scores 330-332 may correspond to outlier classes for which fewer than the threshold number of training samples was used to train machine learning model 300. In some implementations, the outlier classes may include one or more outlier classes for which no training samples were used to train machine learning model 300.

Adder 334 may be configured to determine a first sum of inlier class scores 326-328, which may be expressed as Σ_{c′∈Y}_{_{IN}} p(c′|x)=p(inlier|x). Thus, the output of adder 334 may represent a probability that the input data 302 is an inlier, and this probability may be considered a confidence score of machine learning model 300. Adder 336 may be configured to determine a second sum of outlier class scores 330-332, which may be expressed as Σ_{c′∈Y}_{_{OUT}} p(c′|x)=p(outlier|x). Thus, the output of adder 336 may represent a probability that the input data 302 is an outlier, and this probability may be considered an uncertainty score of machine learning model 300.

Comparator 338 may be configured to determine, based on the first sum of adder 334 and the second sum of adder 336, whether input data 302 corresponds (i) to the plurality of inlier classes (with corresponding inlier class scores 326-328), or (ii) to the plurality of outlier classes (with corresponding outlier class scores 330-332). Stated another way, comparator 338 may be configured to determine, based on the first and second sums, whether input data 302 is an inlier (i.e., an in-distribution input corresponding to the plurality of inlier classes) or an outlier (i.e., an out-of-distribution input corresponding to the plurality of outlier classes). This coarse-grained classification of input data 302 as either an inlier or an outlier may be represented by inlier/outlier classification 340.

Specifically, comparator 338 may be configured to determine that input data 302 is an inlier when the first sum (i.e., the confidence score) exceeds the second sum (i.e., the uncertainty score) by, for example, at least a threshold value (e.g., a confidence score threshold value). Comparator 338 may be configured to determine that input data 302 is an outlier when the first sum does not exceed the second sum by at least the threshold value. For example, comparator 338 may be configured to determine that input data 302 is an outlier when the second sum is equal to or exceeds the first sum.

When comparator 338 determines that input data 302 is an inlier, comparator 338 (or another component of machine learning model 300) may also generate an indication of inlier class 342. Inlier class 342 may be the class associated with a highest corresponding inlier class score of inlier class scores 326-328. That is, when comparator 338 determines that machine learning model 300 is qualified, trusted and/or approved to classify input data 302, comparator 338 may generate an indication of the fine-grained classification of input data 302 into inlier class 342 of the plurality of inlier classes. In some cases, comparator 338 may additionally be configured to determine that the highest inlier class score of inlier class scores 326-332 exceeds a threshold value and, based on this determination, generate the indication of inlier class 342. On the other hand, when comparator 338 determines that machine learning model 300 is not qualified, trusted and/or approved to classify input data 302, comparator 338 may be configured to abstain from generating an indication of the fine-grained classification of input data 302.

### V. Example Model Training Operations

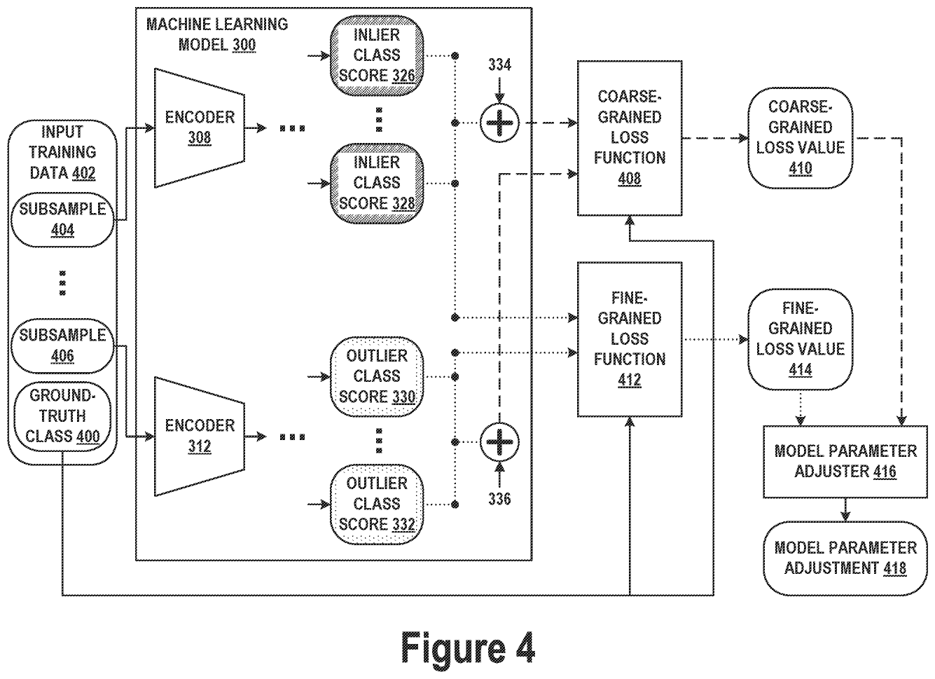

FIG. 4 illustrates an example system for training of machine learning model 300. Specifically, machine learning model 300 may be trained based on input training data 402, which may include a plurality of subsamples 404 through 406 (i.e., subsamples 404-406) and ground-truth class 400. Ground-truth class 400 may indicate the actual class associated with input training data 402. When input training data 402 represents a dermatological condition, ground-truth class 400 may be assigned to input training data 402 by one or more qualified clinicians based on examination of subsamples 404-406. Machine learning model 300 may process input training data 402 and generate based thereon class scores 326-332. Adder 334 may be configured to determine a first (inlier) training sum of inlier class scores 326, and adder 336 may be configured to determine a second (outlier) training sum of outlier class scores 330-332.

Coarse-grained loss function 408 may be configured to determine coarse-grained loss value 410 based on ground-truth class 400 and at least one of the first training sum and/or the second training sum. Specifically, coarse-grained loss value 410 may be indicative of an extent to which machine learning model 300 correctly determined that input training data 402 is an inlier (i.e., ground-truth class 400 is one of the plurality of inlier classes) or an outlier (i.e., ground-truth class 400 is one of the plurality of outlier classes). Thus, coarse-grained loss function 408 may incentivize machine learning model 300 to correctly determine whether it is or is not qualified, trusted, and/or approved to provide a fine-grained classification of previously-unseen input data.

Coarse-grained loss value 410 may be expressed as L_{COARSE}=−Σ_{C∈{IN, OUT}}1(y_{COARSE}=c_{COARSE})log(p(c|x)), where y_{COARSE} represents the coarse-grained classification (i.e., inlier or outlier) of input training data 402, c_{COARSE} represents the coarse-grained classification generated by machine learning model 300, and the statement (y_{COARSE}=c_{COARSE}) is equal to (i) one when y_{COARSE} and c_{COARSE} are equal and (ii) zero otherwise. Accordingly, when ground-truth class 400 indicates that input training data 402 is an inlier, coarse-grained loss value 410 may be expressed as L_{COARSE}=−Σ_{c∈Y}_{_{IN}} log(p(c|x))=−log(p(inlier|x)). Thus, when training data is an inlier, coarse-grained loss function 408 may be configured to determine a negative logarithm of the first training sum generated by adder 334. When ground-truth class 400 indicates that input training data 402 is an outlier, coarse-grained loss value 410 may be expressed as L_{COARSE}=−Σc∈Y_{OUT} log(p(c|x))=−log(p(outlier|x)). Thus, when training data is an outlier, coarse-grained loss function 408 may be configured to determine a negative logarithm of the second training sum generated by adder 336.

Fine-grained loss function 412 may be configured to determine fine-grained loss value 414 based on ground-truth class 400 and at least one of class scores 326-332. Specifically, fine-grained loss value 414 may be indicative of an extent to which machine learning model 300 correctly determined that input training data 402 belongs to ground-truth class 400 from among the plurality of classes corresponding to class scores 326-332. Thus, fine-grained loss function 412 may incentivize machine learning model 300 to correctly classify previously-unseen input data among the plurality of classes corresponding to class scores 326-332.

Fine-grained loss value 414 may be expressed as L_{FINE}=−Σ_{ceY}1(y=c)log(p(c|x)), where y represents ground-truth class 400, c represents the fine-grained classification, generated my machine learning model 300, of input training data 402 among the plurality of classes corresponding to class scores 326-332 (i.e., the class associated with the highest score of class scores 326-332), and the statement (y=c) is equal to (i) one when y and c are equal and (ii) zero otherwise. Thus, coarse-grained loss function 408 may be configured to determine a negative logarithm of the class score determined by machine learning model 300 for ground-truth class 400.

Model parameter adjuster 416 may be configured to determine model parameter adjustment 418 based on coarse-grained loss value 410 and fine-grained loss value 414. For example, Model parameter adjuster may be configured to determine an overall loss value based on a weighted sum of coarse-grained loss value 410 and fine-grained loss value 414. The overall loss value may be expressed as L_{OVERALL}=L_{FINE}+λL_{COARSE}, where λ is a hyperparameter that indicates a relative importance of L_{COARSE} in comparison to L_{FINE}. The values of A may be adjusted to improve and/or optimize performance of machine learning model 300. This combination of coarse-grained loss value 410 and fine-grained loss value 414, as well as the corresponding loss functions 408 and 412, respectively, may be referred to as a hierarchical outlier detection (HOD) loss.

When the overall loss value L_{OVERALL} exceeds a threshold loss value, model parameter adjuster 416 may be configured to determine a gradient of coarse-grained loss function 408 and fine-grained loss function 412 at a point corresponding to the overall loss value L_{OVERALL}. Based on the gradient, model parameter adjuster 416 may be configured to determine model parameter adjustment 418 that will reduce the overall loss value L_{OVERALL}. By repeating this training process with respect to multiple different input training data, parameters of machine learning model 300 may be adjusted until machine learning model 300 is configured to determine, with at least a threshold accuracy, whether previously-unseen input data is an inlier or an outlier, and/or classify previously-unseen inlier input data among the plurality of inlier classes corresponding to inlier class scores 326-328.

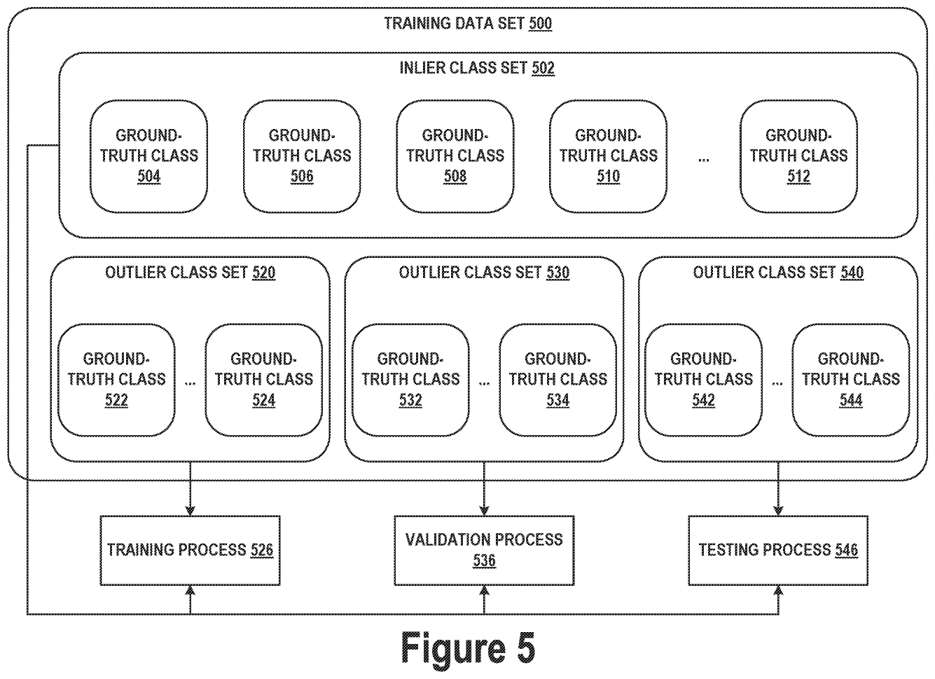

FIG. 5 illustrates additional aspects of training, validation, and testing of machine learning model 300. Specifically, FIG. 5 illustrates training data set 500 that includes inlier class set 502, outlier class set 520, outlier class set 530, and outlier class set 540 (i.e., outlier class sets 520-540). Inlier class set 502 may include ground-truth class 504, ground-truth class 506, ground-truth class 508, and ground-truth class 510 through ground-truth class 512 (i.e., ground-truth classes 504-512). Ground-truth classes 504-512 may represent, for example, the classes in FIG. 2 that are associated with at least the threshold number of samples.

Outlier class set 520 may include ground-truth class 522 through ground-truth class 524 (i.e., ground-truth classes 522-524), outlier class set 530 may include ground-truth class 532 through ground-truth class 534 (i.e., ground-truth classes 532-534), and outlier class set 540 may include ground-truth class 542 through ground-truth class 544 (i.e., ground-truth classes 542-544). Ground-truth classes 522-524, 532-534, and 542-544 may represent, for example, the classes in FIG. 2 that are associated with fewer than the threshold number of samples. Each of outlier class sets 520, 530, and 540 may be disjoint from (i.e., contain non-overlapping and/or mutually exclusive ground-truth classes) inlier class set 502.

Additionally, in some implementations, outlier class sets 520, 530, and 540 may also be disjoint from one another. That is, the plurality of outlier classes present in training data set 500 may be divided into outlier class set 520 to be used as part of training process 526, outlier class set 530 to be used as part of validation process 536, and/or outlier class set 540 to be used as part of testing process 546. Accordingly, machine learning model 300 may include a corresponding neuron for each of ground-truth classes 522-524, but might not include a corresponding neuron for each of ground-truth classes 532-534 and 542-544.

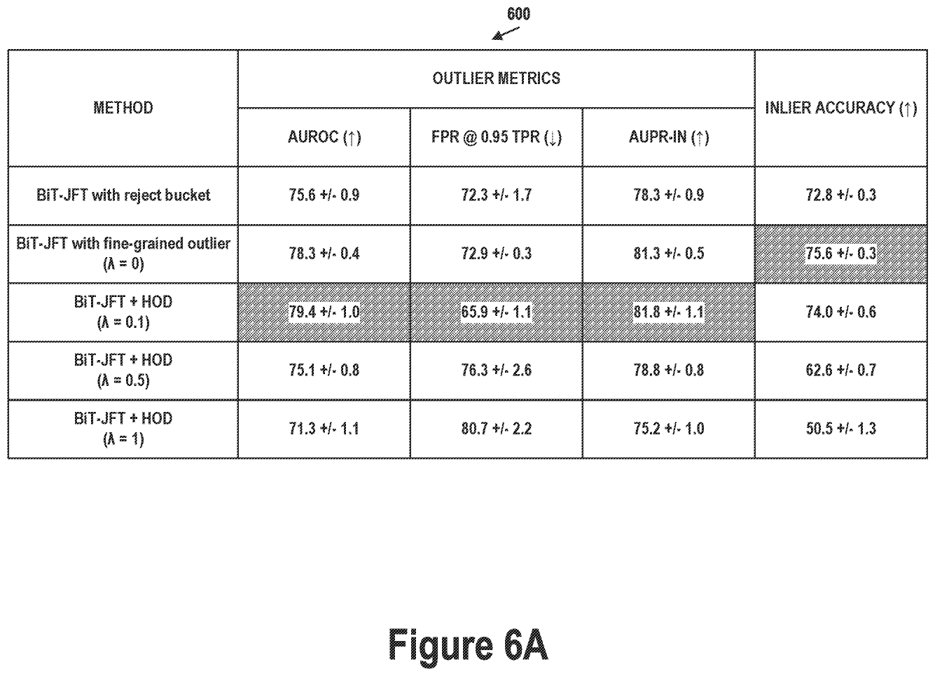

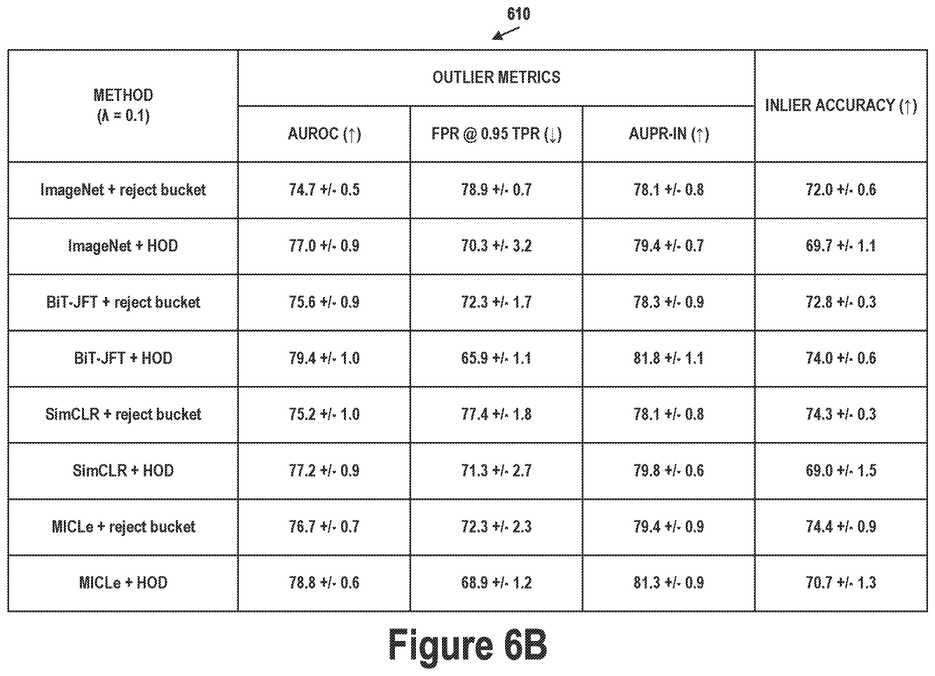

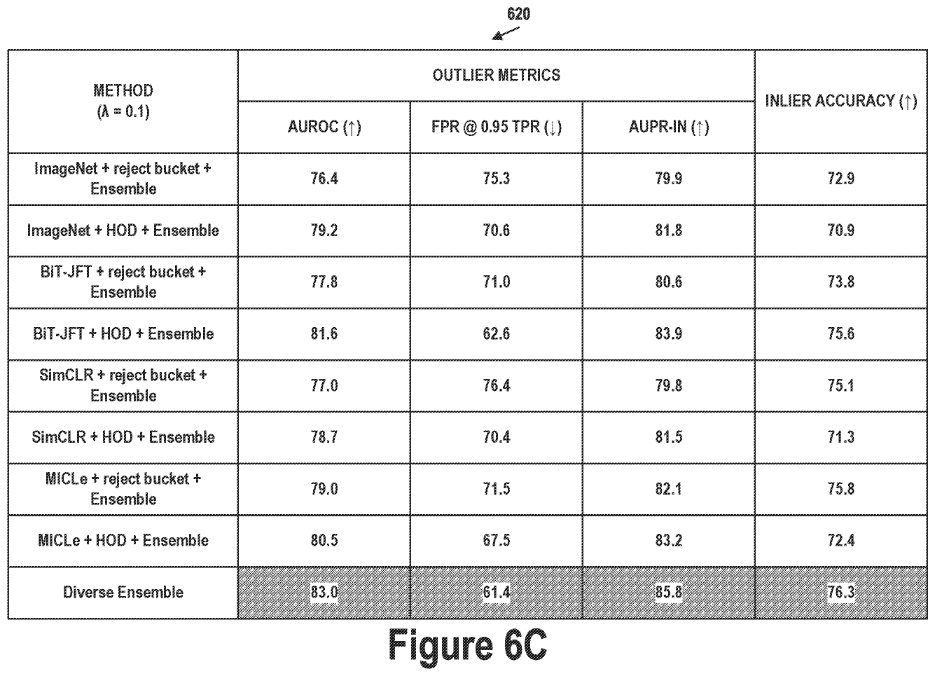

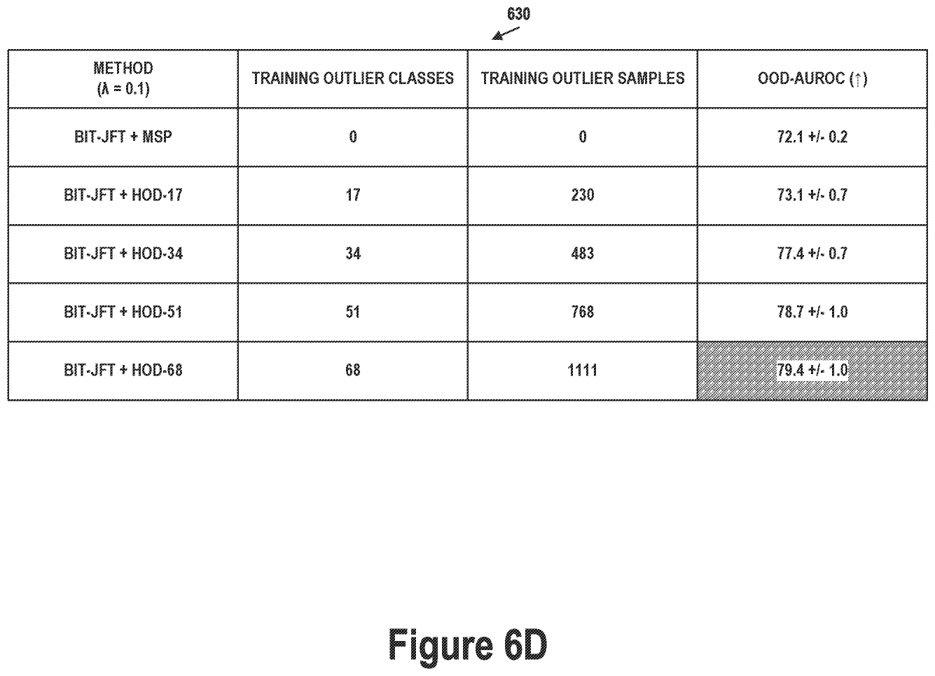

Partitioning training data set 500 in this manner allows for evaluation of the performance of machine learning model 300 with respect to outlier classes that were not explicitly represented as part of training process 526. Specifically, although ground-truth classes 532-534 and 542-544 were not explicitly represented as part of training process 526, training of machine learning model 300 using the coarse-grained and fine-grained loss functions may nevertheless configure machine learning model 300 to determine that input data associated with ground-truth classes 532-534 and 542-544 is an outlier. By withholding entire ground-truth classes from training process 526, rather than only withholding portions of the samples associated with the withheld ground-truth classes, a worst-case performance of machine learning model 300 may be evaluated. When, instead, each of outlier class sets 520, 530, and 540 are used as part of training process 526, performance of machine learning model 300 may be further improved due to the additional training data, as is shown and discussed with respect to FIG. 6D.

Inlier class set 502 may be used for each of training process 526, validation process 536, and testing process 546. Disjoint and non-empty subsets of samples of each of ground-truth classes 504-512 may be used for training process 526, validation process 536, and testing process 546. Thus, validation process 536 and testing process 546 may be executed on previously unseen input data that belongs to inlier classes that were explicitly represented as part of training process 526. Specifically, all inlier classes of inlier class set 502 may be explicitly represented as part of training process 526 because, in addition to determining that previously-unseen inlier input data is an inlier, machine learning model 300 is tasked with determining the specific inlier class to which the previously-unseen inlier input data belongs, and omitting some inlier classes during training process 526 might hinder the latter task.

### VI. Example Testing Results

FIGS. 6A, 6B, 6C, and 6D show results of various performance and/or ablation tests executed using variants of machine learning model 300 on a data set of images of dermatological conditions. Specifically, FIGS. 6A, 6B, 6C, and 6D indicate an inlier classification accuracy and a plurality of outlier metrics for each of a plurality of different variations of machine learning model 300. AUROC represents the area under the receiver operating characteristics curve, with larger values indicating better performance. FPR @ 0.95 TPR represents the false positive rate corresponding to a 95% true positive rate, with smaller values indicating better performance. AUPR-IN represents the area under the inlier precision-recall curve, with larger values indicating better performance. Each test result corresponds to a version of machine learning model 300 that uses, as its encoder(s), a ResNet-101x3 structure.

FIG. 6A includes table 600 that indicates the performance of a version of machine learning model 300 with encoder(s) that have been pre-trained using the BigTransfer (BiT) training process (a transfer learning process discussed in a paper titled “Big Transfer (BiT): General Visual Representation Learning.” authored by Alexander Kolesnikov, Lucas Beyer, Xiaohua Zhai, Joan Puigcerver, Jessica Yung, Sylvain Gelly, and Neil Houlsby, and published as arXiv: 1912.11370v3 on May 5, 2020) using the JFT data set (discussed in a paper titled “Revisiting Unreasonable Effectiveness of Data in Deep Learning Era.” authored by Chen Sun, Abhinav Shrivastava, Saurabh Singh, and Abhinav Gupta, and published as arXiv: 1707.02968v2 on Aug. 4, 2017). For each testing method, five different model instances each trained using (i) different initialization values and (ii) the same sequences of training data were evaluated. The results with respect to each metric are reported as mean+/−standard deviation across the five different model instances. BiT-JFT with reject bucket indicates a version of machine learning model 300 that lacks outlier class scores 330-332, adder 334, adder 336, and comparator 338, and is instead configured to compute one outlier class score (corresponding to the reject bucket) representing a likelihood that the input data is an outlier. BiT-JFT with fine-grained outlier indicates a version of machine learning model 300 that includes outlier class scores 330-332, but lacks adder 334, adder 336, and comparator 338, and is thus associated with weighting value λ=0. The three BiT-JFT+HOD (i.e., hierarchical outlier detection based on HOD) tests indicate versions of machine learning model 300 that have been trained with different weighting values λ (i.e., λ=0.1, λ=0.5, and λ=1).

The highest score with respect to each metric is indicated with darkened shading of the corresponding cell of table 600. BiT+HOD (λ=0.1) performed best with respect to all three outlier metrics, with BiT with fine-grained outlier performing slightly better than BiT+HOD (λ=0.1) on inlier accuracy. This indicates that assigning outlier samples into multiple outlier categories is better than assigning all outlier samples, which may be highly heterogeneous, to a single reject category.

FIG. 6B includes table 610 that indicates the performance of a version of machine learning model 300 with encoder(s) that have been pre-trained using different pre-training techniques. For each testing method, five different model instances each trained using (i) different initialization values and (ii) the same sequences of training data were evaluated. The results with respect to each metric are reported as mean+/−standard deviation across the five different model instances. ImageNet indicates pre-training of the encoder(s) using the ImageNet-1K data set (available at http://www.image-net.org). BiT-JFT indicates pre-training of the encoder(s) using Big Transfer representation learning using the JFT data set. SimCLR indicates pre-training of the encoder(s) using Simple Contrastive Learning (a contrastive learning process discussed in a paper titled “A Simple Framework for Contrastive Learning of Visual Representations,” authored by Ting Chen, Simon Kornblith, Mohammad Norouzi, and Geoffrey Hinton, and published as arXiv: 2002.05709v3 on Jul. 1, 2020) on the ImageNet-1K data set and an additional data set of dermatological images. MICLe indicates pre-training of the encoder(s) using Multi-Instance Contrastive Learning (a contrastive learning process discussed in a paper titled “Big Self-Supervised Models Advance Medical Image Classification,” authored by Shekoofeh Azizi, Basil Mustafa, Fiona Ryan, Zachary Beaver, Jan Frey berg, Jonathan Deaton, Aaron Loh, Alan Karthikesalingam, Simon Kornblith, Ting Chen, Vivek Natarajan, and Mohammad Norouzi, and published as arXiv:2101.05224v1 on Jan. 13, 2021) using the same data as SimCLR. Each pre-training variant with “+ reject bucket” indicates a version of machine learning model 300 that lacks outlier class scores 330-332, adder 334, adder 336, and comparator 338, and is instead configured to compute one outlier class score (corresponding to the reject bucket) representing a likelihood that the input data is an outlier. Each pre-training variant with “+HOD” indicates a version of machine learning model 300 that has been trained using loss functions 408 and 412 with a weighting value of λ=0.1.

Inclusion of HOD in place of the reject bucket improves outlier performance metrics for all four pre-training techniques, and improves inlier performance for BiT pre-training. BiT and contrastive learning (e.g., SimCLR and/or MICLe) pre-training may have complementary properties. Specifically, BiT tries to improve outlier detection performance by better modelling of the inlier distribution. Contrastive learning tries to leverage dermatology-specific features learned during the contrastive training, which might not be useful for inlier classification, but which may be relevant for outlier detection.

FIG. 6C includes table 620 that indicates the performance of a version of machine learning model 300 with encoder(s) that have been pre-trained using different training processes and different ensemble strategies. For each testing method, five different model instances each trained independently using (i) different initialization values and (ii) different random sequences of training data were evaluated. The ImageNet, BiT, SimCLR, and MICLe training techniques are described above. Each pre-training variant with “+HOD” indicates a version of machine learning model 300 that has been trained using loss functions 408 and 412 with a weighting value of λ=0.1. Each pre-training variant with “+ reject bucket” indicates a version of machine learning model 300 as described above (i.e., using weighting value of λ=0). The diverse ensemble includes three model instances pre-trained using BiT-JFT+HOD and two model instances pre-trained using MICLe+HOD, and has been selected using a greedy algorithm that maximizes a mean of (i) the AUROC metric, (ii) 1-FPR @ 95% TPR, and (iii) AUPR-IN on a validation data set. The highest score with respect to each metric is indicated with darkened shading of the corresponding cell of table 620. The diverse ensemble of three BiT-JFT+HOD sub-models and two MICLe+HOD sub-models outperform the other ensembles on outlier metrics, likely due to the distinct and complementary benefits of BiT and MICLe pre-training.

FIG. 6D includes table 630 that indicates the performance of a version of machine learning model 300 with encoder(s) that have been trained using different amounts of outlier training classes and samples. For each testing method, five different model instances pre-trained using BiT-JFT, with weighting value of λ=0.1, and each subsequently trained using (i) different initialization values and (ii) the same sequences of training data were evaluated. The outlier-specific AUROC metric is reported as mean+/−standard deviation across the five different model instances. BiT-JFT+MSP (i.e., max-of-softmax probability) includes 0 outlier classes with 0 corresponding samples. BiT-JFT+HOD-17 includes 17 outlier classes with 230 corresponding samples. BiT-JFT+HOD-34 includes 34 outlier classes with 483 corresponding samples. BiT-JFT+HOD-51 includes 51 outlier classes with 768 corresponding samples. BiT-JFT+HOD-68 includes 68 outlier classes with 1111 corresponding samples. As the number of outlier classes and/or samples increases, outlier detection performance of the machine learning model improves due to the increased exposure to outlier classes and/or samples.

An accuracy A(τ) of outputs at a fixed confidence score threshold τ generated by machine learning model 300 for a plurality of test samples may be represented as A(τ)=Σᵢ 1 (C(xᵢ)>τ, argmax_{y∈Y}_{_{IN}} p(y|xᵢ)=yᵢ)/Σᵢ 1(C(xᵢ)>τ), where C(xᵢ)=p(inlier|xᵢ), machine learning model 300 is configured to generate inlier class 342 (rather than abstain from generating a fine-grained classification) when the sum generated by adder 334 exceeds confidence score threshold τ, where 0<τ<1, xᵢ denotes a particular test sample of the plurality of test samples, and yᵢ denotes a ground-truth label associated with the particular test sample. The diverse ensemble model discussed with respect to FIG. 6C has been found to deliver a higher accuracy than a baseline ensemble model (ImageNet+reject bucket) for all values of confidence score threshold τ, and a higher accuracy for all outlier recall values corresponding to different values of confidence score threshold τ. Additionally, the diverse ensemble model has been found to more frequently abstain from generating erroneous inlier classifications for inlier inputs than the baseline ensemble model at least when τ<0.8.

Alternatively or additionally, a clinical cost associated with erroneous outputs may be determined based on the plurality of test samples for various values of confidence score threshold τ. Specifically, for a given value of confidence score threshold τ, the clinical cost may be increased by (i) a first predetermined value (e.g., 1.0) for each inlier incorrectly classified as belonging to an inlier class that does not match the corresponding ground-truth class, (ii) a second predetermined value (e.g., 0.5) for incorrectly abstaining from classifying an inlier (i.e., incorrectly determining that the inlier is an outlier), and (iii) a third predetermined value (e.g., 1.0) for each outlier incorrectly classified as belonging to an inlier class. The diverse ensemble model discussed has been found to provide a lower clinical cost than a baseline ensemble model for all values of confidence score threshold τ.

### VII. Additional Example Operations

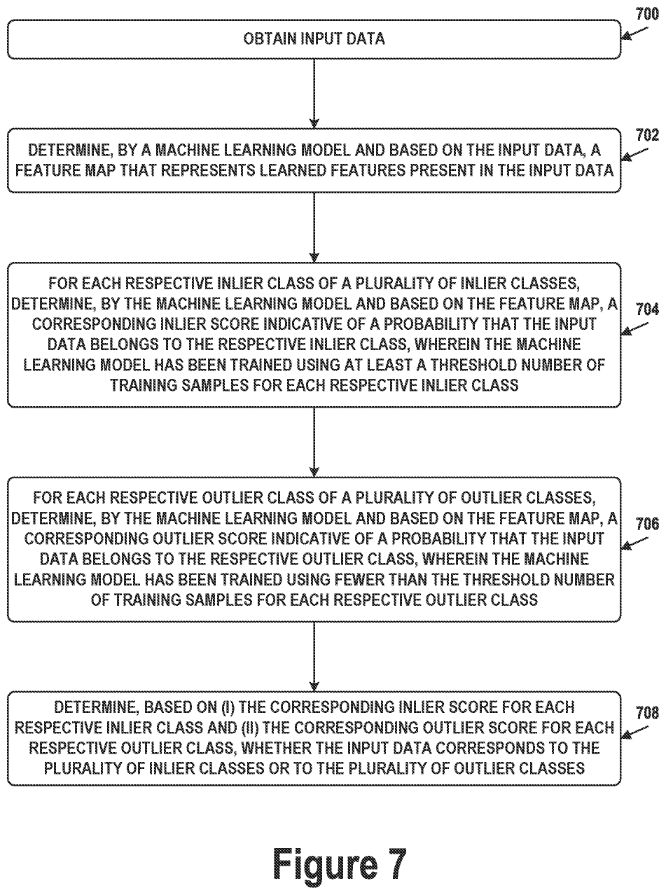

FIG. 7 illustrates a flow chart of operations related to determining whether input data is an inlier or an outlier. The operations may be carried out by computing system 100 and/or machine learning model 300, among other possibilities. The embodiments of FIG. 7 may be simplified by the removal of any one or more of the features shown therein. Further, these embodiments may be combined with features, aspects, and/or implementations of any of the previous figures or otherwise described herein.

Block 700 may involve obtaining input data.

Block 702 may involve determining, by a machine learning model and based on the input data, a feature map that represents learned features present in the input data.

Block 704 may involve, for each respective inlier class of a plurality of inlier classes, determining, by the machine learning model and based on the feature map, a corresponding inlier score indicative of a probability that the input data belongs to the respective inlier class. The machine learning model may have been trained using at least a threshold number of training samples for each respective inlier class.

Block 706 may involve, for each respective outlier class of a plurality of outlier classes, determining, by the machine learning model and based on the feature map, a corresponding outlier score indicative of a probability that the input data belongs to the respective outlier class. The machine learning model may have been trained using fewer than the threshold number of training samples for each respective outlier class.

Block 708 may involve determining, based on (i) the corresponding inlier score for each respective inlier class and (ii) the corresponding outlier score for each respective outlier class, whether the input data corresponds to the plurality of inlier classes or to the plurality of outlier classes.

In some embodiments, when the input data belongs to a class that is not part of the plurality of outlier classes and the plurality of inlier classes, the machine learning model may be configured to determine corresponding inlier scores and corresponding outlier scores indicating that the input data corresponds to the plurality of outlier classes.

In some embodiments, determining whether the input data corresponds to the plurality of inlier classes or to the plurality of outlier classes may include determining (i) a first sum of the corresponding inlier score for each respective inlier class and (ii) a second sum of the corresponding outlier score for each respective outlier class. A disparity between the second sum and the first sum may be determined. Based on determining the disparity, it may be determined whether the input data corresponds to the plurality of inlier classes or to the plurality of outlier classes.

In some embodiments, determining the disparity between the second sum and the first sum may include determining whether the first sum exceeds the second sum or the second sum exceeds the first sum. Determining whether the input data corresponds to the plurality of inlier classes or to the plurality of outlier classes may include, based on determining that the first sum exceeds the second sum, determining that the input data corresponds to the plurality of inlier classes or, based on determining that the second sum exceeds the first sum, determining that the input data corresponds to the plurality of outlier classes.

In some embodiments, determining whether the input data corresponds to the plurality of inlier classes or to the plurality of outlier classes may include determining that the input data corresponds to the plurality of inlier classes and, based on determining that the input data corresponds to the plurality of inlier classes, determining, based on the corresponding inlier score for each respective inlier class, a particular inlier class to which the input data belongs. An indication of the particular inlier class to which the input data belongs may be generated.

In some embodiments, determining whether the input data corresponds to the plurality of inlier classes or to the plurality of outlier classes may include determining that the input data corresponds to the plurality of outlier classes and, based on determining that the input data corresponds to the plurality of outlier classes, generating an indication that the machine learning model is untrained to classify the input data with at least a threshold accuracy.

In some embodiments, the input data may include one or more of: image data, audio data, waveform data, point cloud data, or text data.

In some embodiments, the input data may include a medical image. Determining whether the input data corresponds to the plurality of inlier classes or to the plurality of outlier classes may include determining whether the machine learning model is qualified to generate a medical diagnosis based on the medical image. The medical diagnosis may include a classification of the medical image into a particular inlier class of the plurality of inlier classes.

In some embodiments, the machine learning model may include one or more encoders configured to generate the feature map by processing the input data. The machine learning model may also include a plurality of neurons connected to the one or more encoders and configured to generate, based on the feature map, a vector comprising a plurality of values. Each respective neuron of the plurality of neurons may include a plurality of trainable weights. The machine learning model may further include a softmax operator configured to generate, based on the vector, the corresponding inlier score for each respective inlier class and the corresponding outlier score for each respective outlier class.

In some embodiments, the machine learning model may include an ensemble of a plurality of sub-models. Each respective sub-model of the plurality of sub-models may include: (i) corresponding one or more encoders, (ii) a corresponding plurality of neurons, and (iii) a corresponding softmax operator. Each respective sub-model may have been trained using a different corresponding training procedure. Each respective sub-model may be configured to generate a corresponding set of inlier scores for the plurality of inlier classes and a corresponding set of outlier scores for the plurality of outlier classes. Determining whether the input data corresponds to the plurality of inlier classes or to the plurality of outlier classes may include determining whether the input data corresponds to the plurality of inlier classes or to the plurality of outlier classes based on (i) the corresponding set of inlier scores generated by each respective sub-model and (ii) the corresponding set of outlier scores generated by each respective sub-model.

In some embodiments, a first sub-model of the plurality of sub-models may have been trained using a contrastive training process, and a second sub-model of the plurality of sub-models may have been trained using a transfer learning training process.

In some embodiments, the machine learning model may have been trained using a training process that includes obtaining training input data associated with a ground-truth class. The training process may also include determining, by the machine learning model and based on the training input data, a training feature map that represents learned features present in the training input data. The training process may additionally include, for each respective inlier class of the plurality of inlier classes, determining, by the machine learning model and based on the training feature map, a corresponding inlier training score indicative of a probability that the training input data belongs to the respective inlier class. The training process may yet additionally include, for each respective outlier class of the plurality of outlier classes, determining, by the machine learning model and based on the training feature map, a corresponding outlier training score indicative of a probability that the training input data belongs to the respective outlier class. The training process may further include determining a fine-grained loss value based on a training score of the ground-truth class, where the training score is the corresponding inlier training score for an inlier class corresponding to the ground-truth class or the corresponding outlier training score for an outlier class corresponding to the ground-truth class. The training process may yet further include determining a coarse-grained loss value based on (i) a first training sum of the corresponding inlier training score for each respective inlier class when the ground-truth class is an inlier or (ii) a second training sum of the corresponding outlier training score for each respective outlier class when the ground-truth class is an outlier. The training process may also include adjusting one or more parameters of the machine learning model based on the fine-grained loss value and the coarse-grained loss value.

In some embodiments, determining the fine-grained loss value may include determining a negative logarithm of the training score of the ground-truth class.

In some embodiments, determining the coarse-grained loss value may include determining (i) a negative logarithm of the first training sum when the ground-truth class is an inlier or (ii) a negative logarithm of the second training sum when the ground-truth class is an outlier.

In some embodiments, adjusting the one or more parameters of the machine learning model may include determining a weighted sum of the fine-grained loss value and the coarse-grained loss value, and adjusting the one or more parameters of the machine learning model based on the weighted sum.

In some embodiments, the training input data may form part of a training data set that forms a long-tailed distribution of training samples representing more outlier classes than inlier classes.

In some embodiments, the training process may further include obtaining a training data set that includes a plurality of training samples. Each respective training sample of the plurality of training samples may include training input data associated with a corresponding ground-truth class. The plurality of inlier classes may be determined by identifying, within the training data set, a first plurality of classes each of which is associated with at least the threshold number of training samples. The plurality of outlier classes may be determined by identifying, within the training data set, a second plurality of classes each of which is associated with fewer than the threshold number of training samples.

In some embodiments, the training process may further may further include partitioning the second plurality of classes into a first set of outlier classes and a second set of outlier classes that is disjoint from the first set of outlier classes. The machine learning model may be trained based on the first set of outlier classes. The plurality of outlier classes may be equivalent to the first set of outlier classes. After training the machine learning model based on the first set of outlier classes, performance of the machine learning model may be evaluated based on the second set of outlier classes. The plurality of outlier classes may exclude the second set of outlier classes.

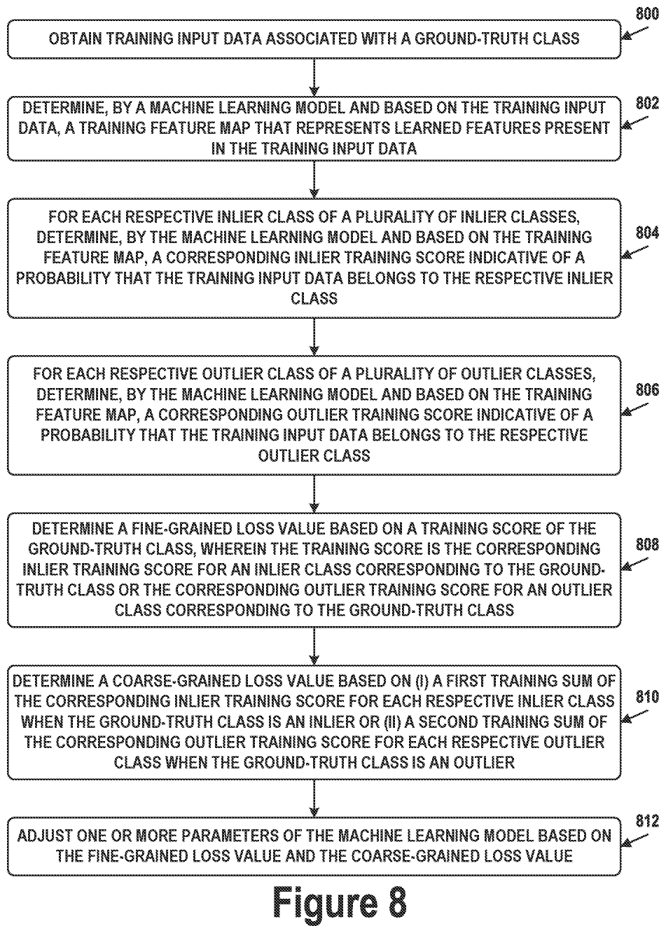

FIG. 8 illustrates a flow chart of operations related to training a machine learning model to determine whether input data is an inlier or an outlier. The operations may be carried out by computing system 100, machine learning model 300, coarse-grained loss function 408, fine-grained loss function 412, and/or model parameter adjuster 418, among other possibilities. The embodiments of FIG. 8 may be simplified by the removal of any one or more of the features shown therein. Further, these embodiments may be combined with features, aspects, and/or implementations of any of the previous figures or otherwise described herein.

Block 800 may involve obtaining training input data associated with a ground-truth class.

Block 802 may involve determining, by a machine learning model and based on the training input data, a training feature map that represents learned features present in the training input data.

Block 804 may involve, for each respective inlier class of a plurality of inlier classes, determining, by the machine learning model and based on the training feature map, a corresponding inlier training score indicative of a probability that the training input data belongs to the respective inlier class.

Block 806 may involve, for each respective outlier class of a plurality of outlier classes, determining, by the machine learning model and based on the training feature map, a corresponding outlier training score indicative of a probability that the training input data belongs to the respective outlier class.

Block 808 may involve determining a fine-grained loss value based on a training score of the ground-truth class, where the training score is the corresponding inlier training score for an inlier class corresponding to the ground-truth class or the corresponding outlier training score for an outlier class corresponding to the ground-truth class.

Block 810 may involve determining a coarse-grained loss value based on (i) a first training sum of the corresponding inlier training score for each respective inlier class when the ground-truth class is an inlier or (ii) a second training sum of the corresponding outlier training score for each respective outlier class when the ground-truth class is an outlier.

Block 812 may involve adjusting one or more parameters of the machine learning model based on the fine-grained loss value and the coarse-grained loss value.

In some embodiments, determining the fine-grained loss value may include determining a negative logarithm of the training score of the ground-truth class.

In some embodiments, determining the coarse-grained loss value may include determining (i) a negative logarithm of the first sum when the ground-truth class is an inlier or (ii) a negative logarithm of the second sum when the ground-truth class is an outlier.

In some embodiments, adjusting the one or more parameters of the machine learning model may include determining a weighted sum of the fine-grained loss value and the coarse-grained loss value, and adjusting the one or more parameters of the machine learning model based on the weighted sum.

In some embodiments, the training input data may form part of a training data set that forms a long-tailed distribution of training samples representing more outlier classes than inlier classes.

In some embodiments, a training data set that includes a plurality of training samples may be obtained. Each respective training sample of the plurality of training samples may include training input data associated with a corresponding ground-truth class. The plurality of inlier classes may be determined by identifying, within the training data set, a first plurality of classes each of which is associated with at least the threshold number of training samples. The plurality of outlier classes may be determined by identifying, within the training data set, a second plurality of classes each of which is associated with fewer than the threshold number of training samples.

In some embodiments, the second plurality of classes may be partitioned into a first set of outlier classes and a second set of outlier classes that is disjoint from the first set of outlier classes. The machine learning model may be trained based on the first set of outlier classes. The plurality of outlier classes may be equivalent to the first set of outlier classes. After training the machine learning model based on the first set of outlier classes, performance of the machine learning model may be evaluated based on the second set of outlier classes. The plurality of outlier classes may exclude the second set of outlier classes.

### VIII. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long-term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

1. A computer-implemented method comprising:
obtaining input data;
determining, by a machine learning model and based on the input data, a feature map that represents learned features present in the input data;
for each respective inlier class of a plurality of inlier classes, determining, by the machine learning model and based on the feature map, a corresponding inlier score indicative of a probability that the input data belongs to the respective inlier class, wherein the machine learning model has been trained using at least a threshold number of training samples for each respective inlier class;
for each respective outlier class of a plurality of outlier classes, determining, by the machine learning model and based on the feature map, a corresponding outlier score indicative of a probability that the input data belongs to the respective outlier class, wherein the machine learning model has been trained using fewer than the threshold number of training samples for each respective outlier class; and
determining, based on (i) the corresponding inlier score for each respective inlier class and (ii) the corresponding outlier score for each respective outlier class, whether the input data corresponds to the plurality of inlier classes or to the plurality of outlier classes.

2. The computer-implemented method of claim 1, wherein, when the input data belongs to a class that is not part of the plurality of outlier classes and the plurality of inlier classes, the machine learning model is configured to determine corresponding inlier scores and corresponding outlier scores indicating that the input data corresponds to the plurality of outlier classes.

3. The computer-implemented method of claim 1, wherein determining whether the input data corresponds to the plurality of inlier classes or to the plurality of outlier classes comprises:
determining (i) a first sum of the corresponding inlier score for each respective inlier class and (ii) a second sum of the corresponding outlier score for each respective outlier class;
determining a disparity between the second sum and the first sum; and
based on determining the disparity, determining whether the input data corresponds to the plurality of inlier classes or to the plurality of outlier classes.

4. The computer-implemented method of claim 3, wherein:
determining the disparity between the second sum and the first sum comprises determining whether the first sum exceeds the second sum or the second sum exceeds the first sum, and
determining whether the input data corresponds to the plurality of inlier classes or to the plurality of outlier classes comprises:
based on determining that the first sum exceeds the second sum, determining that the input data corresponds to the plurality of inlier classes; or
based on determining that the second sum exceeds the first sum, determining that the input data corresponds to the plurality of outlier classes.

5. The computer-implemented method of claim 1, wherein determining whether the input data corresponds to the plurality of inlier classes or to the plurality of outlier classes comprises:
determining that the input data corresponds to the plurality of inlier classes;
based on determining that the input data corresponds to the plurality of inlier classes, determining, based on the corresponding inlier score for each respective inlier class, a particular inlier class to which the input data belongs; and
generating an indication of the particular inlier class to which the input data belongs.

6. The computer-implemented method of claim 1, wherein determining whether the input data corresponds to the plurality of inlier classes or to the plurality of outlier classes comprises:
determining that the input data corresponds to the plurality of outlier classes; and
based on determining that the input data corresponds to the plurality of outlier classes, generating an indication that the machine learning model is untrained to classify the input data with at least a threshold accuracy.

7. The computer-implemented method of claim 1, wherein the input data comprises one or more of: image data, audio data, waveform data, point cloud data, or text data.

8. The computer-implemented method of claim 1, wherein the input data comprises a medical image, and wherein determining whether the input data corresponds to the plurality of inlier classes or to the plurality of outlier classes comprises:
determining whether the machine learning model is qualified to generate a medical diagnosis based on the medical image, wherein the medical diagnosis comprises a classification of the medical image into a particular inlier class of the plurality of inlier classes.

9. The computer-implemented method of claim 1, wherein the machine learning model comprises:
one or more encoders configured to generate the feature map by processing the input data;
a plurality of neurons connected to the one or more encoders and configured to generate, based on the feature map, a vector comprising a plurality of values, wherein each respective neuron of the plurality of neurons comprises a plurality of trainable weights; and
a softmax operator configured to generate, based on the vector, the corresponding inlier score for each respective inlier class and the corresponding outlier score for each respective outlier class.

10. The computer-implemented method of claim 1, wherein the machine learning model comprises an ensemble of a plurality of sub-models, wherein each respective sub-model of the plurality of sub-models comprises: (i) corresponding one or more encoders, (ii) a corresponding plurality of neurons, and (iii) a corresponding softmax operator, wherein each respective sub-model has been trained using a different corresponding training procedure, wherein each respective sub-model is configured to generate a corresponding set of inlier scores for the plurality of inlier classes and a corresponding set of outlier scores for the plurality of outlier classes, and wherein determining whether the input data corresponds to the plurality of inlier classes or to the plurality of outlier classes comprises:
determining whether the input data corresponds to the plurality of inlier classes or to the plurality of outlier classes based on (i) the corresponding set of inlier scores generated by each respective sub-model and (ii) the corresponding set of outlier scores generated by each respective sub-model.

11. The computer-implemented method of claim 10, wherein a first sub-model of the plurality of sub-models has been trained using a contrastive training process, and wherein a second sub-model of the plurality of sub-models has been trained using a transfer learning training process.

12. The computer-implemented method of claim 1, wherein the machine learning model has been trained using a training process comprising:
obtaining training input data associated with a ground-truth class;
determining, by the machine learning model and based on the training input data, a training feature map that represents learned features present in the training input data;
for each respective inlier class of the plurality of inlier classes, determining, by the machine learning model and based on the training feature map, a corresponding inlier training score indicative of a probability that the training input data belongs to the respective inlier class;
for each respective outlier class of the plurality of outlier classes, determining, by the machine learning model and based on the training feature map, a corresponding outlier training score indicative of a probability that the training input data belongs to the respective outlier class;
determining a fine-grained loss value based on a training score of the ground-truth class, wherein the training score is the corresponding inlier training score for an inlier class corresponding to the ground-truth class or the corresponding outlier training score for an outlier class corresponding to the ground-truth class;
determining a coarse-grained loss value based on (i) a first training sum of the corresponding inlier training score for each respective inlier class when the ground-truth class is an inlier or (ii) a second training sum of the corresponding outlier training score for each respective outlier class when the ground-truth class is an outlier; and
adjusting one or more parameters of the machine learning model based on the fine-grained loss value and the coarse-grained loss value.

13. The computer-implemented method of claim 12, wherein determining the fine-grained loss value comprises:
determining a negative logarithm of the training score of the ground-truth class.

14. The computer-implemented method of claim 12, wherein determining the coarse-grained loss value comprises:
determining (i) a negative logarithm of the first training sum when the ground-truth class is an inlier or (ii) a negative logarithm of the second training sum when the ground-truth class is an outlier.

15. The computer-implemented method of claim 12, wherein adjusting the one or more parameters of the machine learning model comprises:
determining a weighted sum of the fine-grained loss value and the coarse-grained loss value; and
adjusting the one or more parameters of the machine learning model based on the weighted sum.

16. The computer-implemented method of claim 12, wherein the training input data forms part of a training data set that forms a long-tailed distribution of training samples representing more outlier classes than inlier classes.

17. The computer-implemented method of claim 12, wherein the training process further comprises:
obtaining a training data set comprising a plurality of training samples, wherein each respective training sample of the plurality of training samples comprises training input data associated with a corresponding ground-truth class;
determining the plurality of inlier classes by identifying, within the training data set, a first plurality of classes each of which is associated with at least the threshold number of training samples; and
determining the plurality of outlier classes by identifying, within the training data set, a second plurality of classes each of which is associated with fewer than the threshold number of training samples.

18. The computer-implemented method of claim 17, wherein the training process further comprises:
partitioning the second plurality of classes into a first set of outlier classes and a second set of outlier classes that is disjoint from the first set of outlier classes;
training the machine learning model based on the first set of outlier classes, wherein the plurality of outlier classes is equivalent to the first set of outlier classes; and
after training the machine learning model based on the first set of outlier classes, evaluating performance of the machine learning model based on the second set of outlier classes, wherein the plurality of outlier classes excludes the second set of outlier classes.

19. A system comprising:
a processor; and
a non-transitory computer-readable medium having stored thereon instructions that, when executed by the processor, cause the processor to perform operations comprising:
obtaining input data;
determining, by a machine learning model and based on the input data, a feature map that represents learned features present in the input data;
for each respective inlier class of a plurality of inlier classes, determining, by the machine learning model and based on the feature map, a corresponding inlier score indicative of a probability that the input data belongs to the respective inlier class, wherein the machine learning model has been trained using at least a threshold number of training samples for each respective inlier class;
for each respective outlier class of a plurality of outlier classes, determining, by the machine learning model and based on the feature map, a corresponding outlier score indicative of a probability that the input data belongs to the respective outlier class, wherein the machine learning model has been trained using fewer than the threshold number of training samples for each respective outlier class; and
determining, based on (i) the corresponding inlier score for each respective inlier class and (ii) the corresponding outlier score for each respective outlier class, whether the input data corresponds to the plurality of inlier classes or to the plurality of outlier classes.

20. A non-transitory computer-readable medium having stored thereon instructions that, when executed by a computing device, cause the computing device to perform operations comprising:
obtaining input data;
determining, by a machine learning model and based on the input data, a feature map that represents learned features present in the input data;
for each respective inlier class of a plurality of inlier classes, determining, by the machine learning model and based on the feature map, a corresponding inlier score indicative of a probability that the input data belongs to the respective inlier class, wherein the machine learning model has been trained using at least a threshold number of training samples for each respective inlier class;
for each respective outlier class of a plurality of outlier classes, determining, by the machine learning model and based on the feature map, a corresponding outlier score indicative of a probability that the input data belongs to the respective outlier class, wherein the machine learning model has been trained using fewer than the threshold number of training samples for each respective outlier class; and
determining, based on (i) the corresponding inlier score for each respective inlier class and (ii) the corresponding outlier score for each respective outlier class, whether the input data corresponds to the plurality of inlier classes or to the plurality of outlier classes.
